(19) United States
(12) Patent Application Publication
(10) Pub. No.: US 2026/0200746 A1
(43) Pub. Date: Jul. 16, 2026

(54) AMMONIA SYNTHESIS SYSTEM

(71) Applicants: KABUSHIKI KAISHA TOYOTA CHUO KENKYUSHO, Nagakute-shi, Aichi-ken (JP); TOYOTA JIDOSHA KABUSHIKI KAISHA, Toyota-shi, Aichi-ken (JP); NATIONAL INSTITUTE OF ADVANCED INDUSTRIAL SCIENCE AND TECHNOLOGY, Tokyo (JP)

(72) Inventors: Yoshihiro GOTO, Nagakute-shi (JP); Masashi KIKUGAWA, Nagakute-shi (JP); Kiyoshi YAMAZAKI, Nagakute-shi (JP); Masakazu AOKI, Nagakute-shi (JP); Naoki BABA, Nagakute-shi (JP); Hideyuki TAKAGI, Tsukuba-shi (JP); Tetsuya NANBA, Tsukuba-shi (JP); Yuichi MANAKA, Tsukuba-shi (JP); Masayasu NISHI, Tsukuba-shi (JP); Akinori SATOU, Mishima-shi (JP); Hideyuki MATSUMOTO, Tokyo (JP); Shinichi OOKAWARA, Tokyo (JP)

(73) Assignees: KABUSHIKI KAISHA TOYOTA CHUO KENKYUSHO, Nagakute-shi, Aichi-ken (JP); TOYOTA JIDOSHA KABUSHIKI KAISHA, Toyota-shi, Aichi-ken (JP); NATIONAL INSTITUTE OF ADVANCED INDUSTRIAL SCIENCE AND TECHNOLOGY, Tokyo (JP)

(21) Appl. No.: 19/135,576

(22) PCT Filed: Oct. 31, 2023
(86) PCT No.: PCT/JP2023/039306

§ 371 Date: Jun. 4, 2025

(30) Foreign Application Priority Data
Dec. 5, 2022 (JP) 2022-194303
Apr. 26, 2023 (JP) 2023-072031

(51) Int. Cl. C01C 1/04

(52) U.S. Cl. CPC C01C 1/0482

(57) ABSTRACT

An ammonia synthesis system for synthesizing ammonia includes a reactor accommodating a catalyst for promoting a synthesis reaction of ammonia from a reactant gas containing hydrogen and nitrogen and a controller that controls an H₂/N₂ ratio that is a ratio of hydrogen to nitrogen in the reactant gas introduced into the reactor. The controller controls the H₂/N₂ ratio during a pre-activation operation for raising a temperature of the catalyst to an activation temperature associated with activation of the catalyst, to be a value different from the H₂/N₂ ratio during a post-activation operation that is an operation after the temperature of the catalyst reaches the activation temperature.

### TECHNICAL FIELD

The present invention relates to an ammonia synthesis system.

### Background Art

Conventionally, an ammonia synthesis system is known in which ammonia is synthesized by introducing a reactant gas containing nitrogen (N₂) and hydrogen (H₂) into a reactor accommodating a catalyst. As such an ammonia synthesis system, for example, Patent Literature 1 discloses an ammonia synthesis system in which an intermediate product gas is cooled using a purge gas or a cooler. Furthermore, Patent Literature 2 discloses an ammonia synthesis system in which ammonia is synthesized by setting the concentration of ammonia gas in a circulating gas used for ammonia synthesis to 3% by volume or more.

### CITATION LIST

### Patent Literature

### [PTL 1]

Patent Literature 1: JP 2018-203603 A

### [PTL 2]

Patent Literature 2: JP 2020-66573 A

### SUMMARY OF INVENTION

### Technical Problem

A ratio of hydrogen to nitrogen (H₂/N₂ ratio) in a reactant gas introduced into a catalyst is one of parameters that determine an ammonia synthesis rate. An appropriate H₂/N₂ ratio to increase an ammonia synthesis rate varies depending on, for example, the temperature of the catalyst and whether the inside of a reactor is in an equilibrium state. However, the ammonia synthesis systems disclosed in Patent Literatures 1 and 2 do not take into consideration control of the H₂/N₂ ratio, and there is room for improvement.

The present invention has been made to solve at least a part of the above-mentioned problems, and an object of the present invention is to provide an ammonia synthesis system that can efficiently synthesize ammonia.

### Solution to Problem

The present invention has been made to solve at least part of the above-mentioned problems, and can be realized in the following aspects.
(1) According to an aspect of the present invention, an ammonia synthesis system is provided. The ammonia synthesis system includes a reactor accommodating a catalyst for promoting a synthesis reaction of ammonia from a reactant gas containing hydrogen and nitrogen and a controller that controls an H₂/N₂ ratio that is a ratio of hydrogen to nitrogen in the reactant gas introduced into the reactor. The controller controls the H₂/N₂ ratio during a pre-activation operation for raising a temperature of the catalyst to an activation temperature associated with activation of the catalyst, to be a value different from the H₂/N₂ ratio during a post-activation operation that is an operation after the temperature of the catalyst reaches the activation temperature.

According to this configuration, the H₂/N₂ ratio in the reactant gas introduced before the activation of the catalyst and the H₂/N₂ ratio in the reactant gas introduced after the activation of the catalyst can be controlled to be different values. Therefore, the H₂/N₂ ratio in the reactant gas introduced into the catalyst can be adjusted to an appropriate value for each of the pre-activation duration and the post-activation duration. Therefore, ammonia can be synthesized more efficiently than in a case where the same H₂/N₂ ratio in the reactant gas introduced into the catalyst is used for both of the pre-activation duration and the post-activation duration.
(2) In the ammonia synthesis system of the above aspect, the controller may control the H₂/N₂ ratio during the pre-activation operation to be smaller than the H₂/N₂ ratio during the post-activation operation.
   In the case where an ammonia synthesis system includes a catalyst in which the H₂/N₂ ratio appropriate for ammonia synthesis before catalyst activation is smaller than the H₂/N₂ ratio appropriate for ammonia synthesis after catalyst activation, this configuration allows a reactant gas with an appropriate H₂/N₂ ratio to be introduced into the catalyst for each of the pre-activation duration and the post-activation duration, thereby enabling ammonia to be efficiently synthesized.
(3) In the ammonia synthesis system of the above aspect, during the pre-activation operation, when a downstream ammonia concentration detected downstream of the catalyst is higher than a comparative concentration obtained by multiplying a predetermined ratio by an ammonia concentration in an equilibrium state calculated from the temperature of the catalyst, the controller may perform increase control to increase the H₂/N₂ ratio, each time the downstream ammonia concentration after a lapse of a set time from increasing the H₂/N₂ ratio becomes higher than the downstream ammonia concentration that triggered the last increase control and becomes higher than the comparative concentration, the controller may additionally perform the increase control, and when the downstream ammonia concentration after a lapse of the set time from increasing the H₂/N₂ ratio is lower than the downstream ammonia concentration that triggered the last increase control, the controller may perform decrease control to restore the H₂/N₂ ratio to the H₂/N₂ ratio before the last increase control.

According to this configuration, during the pre-activation operation, each time the downstream ammonia concentration after the set time has elapsed since the H₂/N₂ ratio was increased becomes higher than the downstream ammonia concentration that triggered the last increase control and then becomes higher than the comparative concentration, additional increase control is performed, and thus the H₂/N₂ ratio in the reactant gas during the pre-activation operation can be increased stepwise to approach an optimum value. Therefore, ammonia can be synthesized more efficiently during the pre-activation operation. On the other hand, during the pre-activation operation, if the downstream ammonia concentration after the set time has elapsed since the H₂/N₂ ratio was increased is lower than the downstream ammonia concentration that triggered the last increase control, then the decrease control is performed, and thus it is possible to prevent the H₂/N₂ ratio in the reactant gas during the pre-activation operation from continuing to increase beyond the optimal value.
(4) In the ammonia synthesis system of the above aspect, the controller may control a flow rate of the reactant gas introduced into the reactor, and the controller may control the flow rate of the reactant gas during the pre-activation operation to be smaller than the flow rate during the post-activation operation.

According to this configuration, the flow rate of the reactant gas during the pre-activation operation is controlled to be smaller than that during the post-activation operation, and thus the reactant gas that has been introduced into the reactor and then heated by the ammonia synthesis reaction can be retained in the reactor for a longer period of time. As a result, the contact time between the heated reactant gas and the catalyst can be extended, and the temperature rise of the catalyst can be promoted.
(5) The ammonia synthesis system of the above aspect may further include a cooler that cools a post-reaction gas discharged from the reactor, and a flow path switching portion that switches a flow path of the post-reaction gas between a first flow path for circulating the post-reaction gas to an upstream side of the reactor without passing through the cooler and a second flow path for feeding the post-reaction gas to the cooler. In the ammonia synthesis system, during the pre-activation operation, when the temperature of the catalyst is lower than a first set temperature set within a temperature range lower than the activation temperature, the controller may control the flow path switching portion to switch the flow path to the first flow path, and when the temperature of the catalyst is equal to or higher than the first set temperature, the controller may control the flow path switching portion to switch the flow path to the second flow path.

According to this configuration, while the temperature of the catalyst is lower than the first set temperature, the post-reaction gas is circulated again to the upstream side of the reactor without being cooled by the cooler, and thus the thermal energy of the post-reaction gas can be reused to heat the catalyst. In addition, since a relatively large amount of unreacted hydrogen and unreacted nitrogen remains in the post-reaction gas while the temperature of the catalyst is lower than the first set temperature, the amount of reactant gas newly introduced into the reactor can be reduced depending on the amount of circulated post-reaction gas. That is, according to this configuration, by circulating the post-reaction gas, it is possible to reduce the energy required to generate the reactant gas (particularly the energy required to generate hydrogen) and the thermal energy required to heat the reactant gas.
(6) In the ammonia synthesis system of the above aspect, during the post-activation operation, the controller may perform temperature reduction control to reduce the temperature of the catalyst when the temperature of the catalyst is higher than a second set temperature set within a temperature range higher than the activation temperature. When the catalyst is activated, the temperature of the catalyst rises rapidly. Such rapid increase may cause the catalyst temperature to remain high and thus cause thermal degradation of the catalyst. According to this configuration, the temperature reduction control is performed when the temperature of the catalyst is higher than the second set temperature, and thus the risk of thermal degradation of the catalyst can be reduced.

The present invention can be realized in various forms, for example, in the form of an ammonia synthesis system, an ammonia production plant, an ammonia production apparatus, an apparatus and system including them, an ammonia production method, an ammonia synthesis method, a computer program for implementing the apparatuses and methods, a server device for distributing the computer program, and a non-transitory storage medium storing the computer program.

### BRIEF DESCRIPTION OF DRAWINGS

FIG. 1 is an explanatory diagram illustrating a configuration of an ammonia synthesis system according to a first embodiment.

FIG. 2 is an explanatory diagram illustrating flow of a reactant gas inside a reactor.

FIG. 3 is an explanatory diagram showing the concentration of ammonia synthesized using a Ru catalyst commonly used.

FIG. 4 is an explanatory diagram showing results of measuring temperature change of a first catalyst over time.

FIG. 5 is an explanatory diagram showing results of measuring temperature changes of reactant gases over time.

FIG. 6 is an explanatory diagram showing temperatures of reactant gases at a catalyst activation time and a reaction stabilization time.

FIG. 7 is an explanatory diagram showing the temperature of the first catalyst at the catalyst activation time and the reaction stabilization time.

FIG. 8 is an explanatory diagram showing elapsed times until the first catalyst is activated.

FIG. 9 is an explanatory diagram showing synthesized ammonia concentrations at the reaction stabilization time.

FIG. 10 is a flowchart illustrating an example of a procedure for a control process of an H₂/N₂ ratio.

FIG. 11 is a flowchart illustrating an example of a procedure for a varying process of the H₂/N₂ ratio.

FIG. 12 is an explanatory diagram illustrating a configuration of an ammonia synthesis system according to a third embodiment.

FIG. 13 is an explanatory diagram showing transition until the temperature change of the first catalyst is stabilized.

FIG. 14 is a flowchart illustrating an example of a procedure for a flow path switching process.

FIG. 15 is a flowchart illustrating an example of a procedure for a temperature adjustment process.

### DESCRIPTION OF EMBODIMENTS

### Example 1

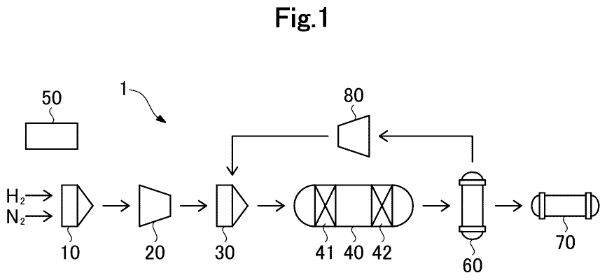

FIG. 1 is an explanatory diagram illustrating a configuration of an ammonia synthesis system 1 according to an embodiment of the present invention. The ammonia synthesis system 1 is a system that synthesizes ammonia from a reactant gas containing hydrogen and nitrogen using a catalyst. The ammonia synthesis system 1 includes a first mixer 10, a first compressor 20, a second mixer 30, a reactor 40, a controller 50, a gas-liquid separator 60, a tank 70, and a second compressor 80.

The first mixer 10 mixes hydrogen supplied from a hydrogen tank (not illustrated) and nitrogen supplied from a nitrogen tank (not illustrated) to generate a reactant gas containing hydrogen and nitrogen. The first compressor 20 compresses the product gas fed from the first mixer 10 and then feeds the product gas to the second mixer 30. The second mixer 30 further mixes the product gas fed from the first mixer 10 and then feeds the product gas to the reactor 40.

Inside the reactor 40, ammonia is synthesized using the reactant gas introduced from the second mixer 30. The reactor 40 accommodates a first catalyst 41 and a second catalyst 42 therein. The first catalyst 41 and the second catalyst 42 are arranged in the reactor 40 in this order from the upstream side. The first catalyst 41 and the second catalyst 42 promote a synthesis reaction for synthesizing ammonia from the reactant gas. The controller 50 adjusts the hydrogen and nitrogen amounts supplied to the first mixer 10 to control the H₂/N₂ ratio, which is the ratio of hydrogen to nitrogen in the reactant gas introduced into the reactor 40. The control by the controller 50 will be described in detail later.

The gas-liquid separator 60 cools a post-reaction gas that has passed through the first catalyst 41 and the second catalyst 42 and been then discharged from the reactor 40, and thereby separates liquid ammonia from the post-reaction gas. The separated liquid ammonia is stored in the tank 70. On the other hand, the post-reaction gas from which the liquid ammonia has been separated is compressed in the second compressor 80 and then fed to the second mixer 30 again.

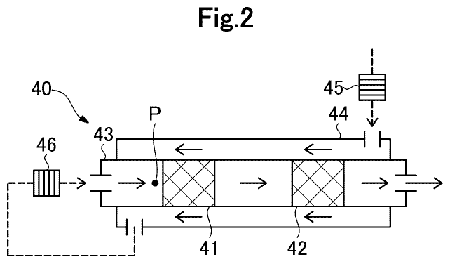

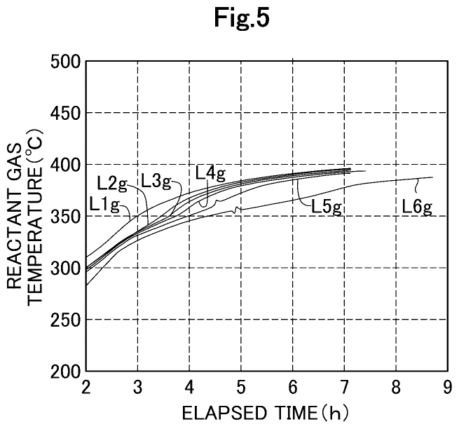

FIG. 2 is an explanatory diagram illustrating the flow of the reactant gas that is introduced into and then discharged from the reactor 40. The reactor 40 has an inner pipe 43 and an outer pipe 44. The inner pipe 43 has a cylindrical shape and accommodates the first catalyst 41 and the second catalyst 42 therein. The outer pipe 44 has a cylindrical shape and covers the inner pipe 43. The ammonia synthesis system 1 further includes an upstream heater 45 and a downstream heater 46 in addition to the components illustrated in FIG. 1. The upstream heater 45 is provided in a pipe (not illustrated) that connects the second mixer 30 and the reactor 40. The downstream heater 46 is provided in a pipe (not illustrated) that connects a downstream end portion of the outer pipe 44 and an upstream end portion of the inner pipe 43. A position P is a position upstream of the first catalyst 41 in the flow direction of the reactant gas flowing through the reactor 40, and will be referred to in description of FIG. 5 described later.

The reactant gas fed from the second mixer 30 to the reactor 40 is heated in the upstream heater 45 and then introduced into a space inside the outer pipe 44 (and outside the inner pipe 43), and then reaches the downstream heater 46. The reactant gas is then heated again in the downstream heater 46, passes through the first catalyst 41 and the second catalyst 42, and is then discharged from the reactor 40.

Next, it will be explained that the H₂/N₂ ratio appropriate for increasing the ammonia synthesis rate varies depending on, for example, the temperature of the catalysts (first catalyst 41, second catalyst 42) and whether the inside of the reactor 40 is in an equilibrium state.

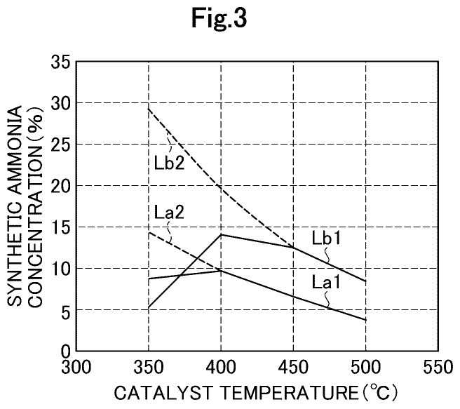

FIG. 3 is an explanatory diagram showing concentration of ammonia synthesized when a reactant gas is introduced into a reactor accommodating a Ru catalyst commonly used (not illustrated). In FIG. 3, the horizontal axis indicates the temperature of the Ru catalyst, and the vertical axis indicates the synthetic ammonia concentration (%) in a post-reaction gas discharged from the reactor. A solid line segment Lal indicates the ammonia synthesis concentration at each temperature when a reactant gas (the H₂/N₂ ratio, 0.5) is introduced into the reactor before the ammonia equilibrium concentration is reached. Here, the ammonia equilibrium concentration refers to the ammonia concentration in the reactor when the ammonia synthesis reaction and its reverse reaction are in equilibrium under the temperature and pressure conditions in the reactor. A dashed line segment La2 indicates the ammonia synthesis concentration at each temperature when a reactant gas (the H₂/N₂ ratio, 0.5) is introduced into the reactor in a state where the ammonia equilibrium concentration has been reached. A part of the line segment La2 above 400° C. overlaps with the line segment La1. On the other hand, a solid line segment Lb1 indicates the ammonia synthesis concentration at each temperature when a reactant gas (the H₂/N₂ ratio, 1.5) is introduced into the reactor before the ammonia equilibrium concentration is reached. A dashed line segment Lb2 indicates the ammonia synthesis concentration at each temperature when a reactant gas (the H₂/N₂ ratio, 1.5) is introduced into the reactor in a state where the ammonia equilibrium concentration has been reached.

In cases before the ammonia equilibrium concentration is reached as shown by the line segments Lal and Lb1, when the temperature is 370° C. or higher, introducing the reactant gas (the H₂/N₂ ratio, 1.5) promotes ammonia synthesis at a higher degree than introducing the reactant gas (the H₂/N₂ ratio, 0.5), but when the temperature is lower than 370° C., introducing the reactant gas (the H₂/N₂ ratio, 0.5) promotes ammonia synthesis at a higher degree than introducing the reactant gas (the H₂/N₂ ratio, 1.5).

Furthermore, in cases where the ammonia equilibrium concentration is reached as shown by the line segments La2 and Lb2, a lower temperature results in more efficient ammonia synthesis for both the reactant gas (the H₂/N₂ ratio, 0.5) and the reactant gas (the H₂/N₂ ratio, 1.5), and introducing the reactant gas (the H₂/N₂ ratio, 1.5) promotes ammonia synthesis at a higher degree than introducing the reactant gas (the H₂/N₂ ratio, 0.5). That is, the appropriate H₂/N₂ ratio for increasing the ammonia synthesis rate varies depending on the temperature of the catalyst and whether the reactor is in an equilibrium state.

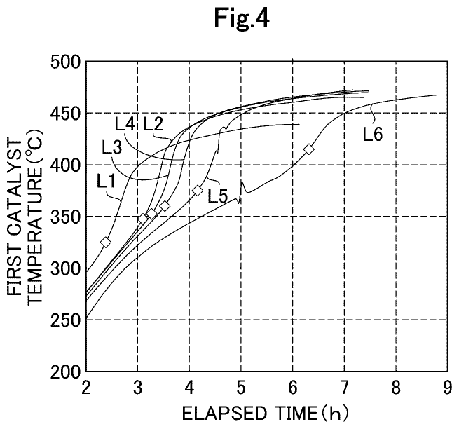

Returning to the description of the ammonia synthesis system 1 of the first embodiment. FIG. 4 shows measurement results of temperature change of the first catalyst 41 versus elapsed time from start of introduction of the reactant gas into the reactor 40. In FIG. 4, the horizontal axis indicates the elapsed time (h), and the vertical axis indicates the temperature (C) of the first catalyst 41. Line segments L1 to L6 shown in FIG. 4 each represent the temperature change over time of the first catalyst 41 pretreated in a reducing atmosphere at 600° C. under atmospheric pressure, when reactant gases with different H₂/N₂ ratios are introduced into the reactor 40 under conditions where a gauge pressure is 8 MPaG and the temperatures of the reactant gas passing through the upstream heater 45 and the downstream heater 46 are 350° C. and 400° C., respectively. In detail, the line segments L1, L2, L3, L4, L5, and L6 represent the temperature change of the first catalyst 41 over time when reactant gases having H₂/N₂ ratios of 0.5, 1.0, 1.25, 1.5, 2.0, and 3.0, respectively, are introduced into the reactor 40.

As shown in FIG. 4, once the introduction of the reactant gas into the reactor 40 is started, the temperature of the first catalyst 41 starts to rise due to the exothermic ammonia synthesis reaction. Thereafter, once the temperature exceeds a certain temperature (the temperature indicated by the open diamond) as a result of continuous temperature rise, the temperature of the first catalyst 41 begins to rise rapidly. This rapid increase is caused by activation of the first catalyst 41 due to the continuous temperature rise and further promotion of the ammonia synthesis reaction. The certain temperature here corresponds to an activation temperature associated with activation of the first catalyst 41. The open diamonds on the line segments L1 to L6 indicate activation temperatures that are preset based on experimental results or the like. In the ammonia synthesis system 1, the operation from when the introduction of the reactant gas into the reactor 40 is started to when the temperature of the first catalyst 41 is raised to the activation temperature is referred to as a pre-activation operation, and the operation after the temperature of the first catalyst 41 reaches the activation temperature is referred to as a post-activation operation. In the present embodiment, the controller 50 controls the H₂/N₂ ratio in the reactant gas introduced into the reactor 40 during the pre-activation operation, to be a value different from the H₂/N₂ ratio in the reactant gas introduced into the reactor 40 during the post-activation operation. The reason for performing such control is that it has been confirmed from the results shown in FIG. 4 described above and each of FIGS. 5 to 9 described below that it is preferable from the viewpoint of efficient ammonia synthesis to control the H₂/N₂ ratio in the reactant gas introduced into the reactor 40 to be different values before and after the activation of the first catalyst 41.

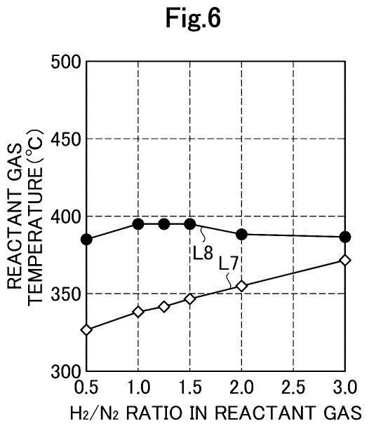

FIG. 5 shows measurement results of temperature change of the reactant gas versus elapsed time from start of introduction of the reactant gas into the reactor 40. FIG. 5 shows the change over time in temperature of the reactant gas passing through the position P (see FIG. 2). In FIG. 5, the horizontal axis indicates the elapsed time (h) and the vertical axis indicates the temperature (C) of the reactant gas. Line segments Llg to Log in FIG. 5 each indicate the change over time in the temperature of the reactant gas when reactant gases having the H 2/N₂ ratio of 0.5, 1.0, 1.25, 1.5, 2.0, and 3.0, respectively, are introduced into the reactor 40. Similarly to the measurement result of FIG. 4, the results shown in FIG. 5 and in each of FIGS. 6 to 9 described later are the results of measurements carried out under conditions where a gauge pressure is 8 MPaG and temperatures of the reactant gas passing through the upstream heater 45 and the downstream heater 46 are 350° C. and 400° C., respectively. As shown in FIG. 5, for all the reactant gases with the different H₂/N₂ ratios, the temperature of the reactant gas increased with time after the introduction of the reactant gas into the reactor 40 was started. This temperature rise is due to the reactor 40 being heated over time by introduction of the heated reactant gas.

FIG. 6 shows correspondence relationship between reactant gases each having a different H₂/N₂ ratio and being introduced into the reactor 40 and temperatures of the reactant gases at the position P (see FIG. 1) at a catalyst activation time and a reaction stabilization time. Here, the catalyst activation time refers to a timing when the temperature of the first catalyst 41 reaches the activation temperature. The reaction stabilization time refers to a timing when the temperature change of the first catalyst 41 becomes equal to or less than 1° C./5 min for the first time after the catalyst activation time. After the reaction stabilization time, the inside of the reactor 40 is in an equilibrium state. In FIG. 4, this corresponds to timings on the line segments L1 to L6, at which the temperature rise of the first catalyst 41 starts to slow down after exceeding the activation temperature. In FIG. 6, the horizontal axis indicates the H₂/N₂ ratio in the reactant gas, and the vertical axis indicates the temperature (C) of the reactant gas. The line segment L7 shown in FIG. 6 indicates correspondence relationship between the temperature of the reactant gas at the position P at the catalyst activation time and each reactant gas with a different H₂/N₂ ratio introduced into the reactor 40. On the other hand, the line segment L8 shown in FIG. 6 indicates correspondence relationship between the temperature of the reactant gas at the position P at the reaction stabilization time and each reactant gas with a different H₂/N₂ ratio introduced into the reactor 40. From the results shown by the line segment L7, within the range of the H₂/N₂ ratio in the reactant gas of 0.5 to 3.0, the smaller the H₂/N₂ ratio, the lower the temperature of the reactant gas at the position P at the catalyst activation time.

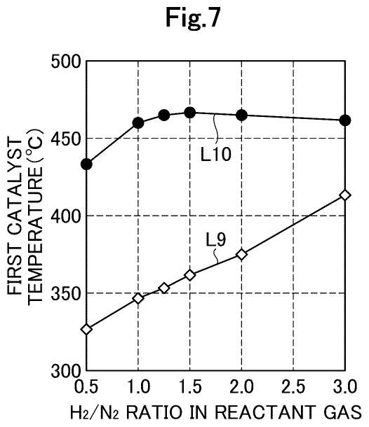

FIG. 7 shows a correspondence relationship between each reactant gas with a different H₂/N₂ ratio introduced into the reactor 40 and the temperature of the first catalyst 41 at the catalyst activation time and the reaction stabilization time. In FIG. 7, the horizontal axis indicates the H₂/N₂ ratio in the reactant gas, and the vertical axis indicates the temperature (° C.) of the first catalyst 41. A line segment L9 shown in FIG. 7 indicates correspondence relationship between the temperature of the first catalyst 41 at the catalyst activation time and each reactant gas with a different H₂/N₂ ratio introduced into the reactor 40. On the other hand, a line segment L10 shown in FIG. 7 indicates correspondence relationship between the temperature of the first catalyst 41 at the reaction stabilization time and each reactant gas with a different H₂/N₂ ratio introduced into the reactor 40. From the results shown by the line segment L9, it was found that within the range of the H₂/N₂ ratio in the reactant gas of 0.5 to 3.0, a smaller H₂/N₂ ratio can activate the first catalyst 41 at a lower temperature. That is, among the H₂/N₂ ratios of the reactant gas ranging from 0.5 to 3.0, the input energy for activating the first catalyst 41 can be minimized when the H₂/N₂ ratio in the reactant gas is set to 0.5.

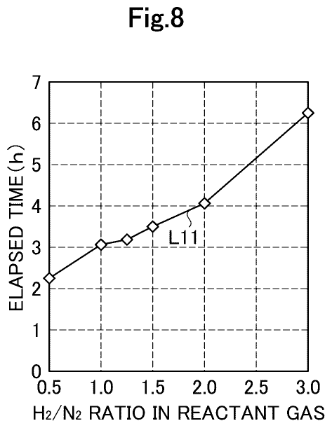

FIG. 8 shows a line segment L11 which represents correspondence relationship between each reactant gas with a different H₂/N₂ ratio introduced into the reactor 40 and an elapsed time from when the introduction of the reactant gas into the reactor 40 is started until the first catalyst 41 is activated. In FIG. 8, the horizontal axis indicates the H₂/N₂ ratio in the reactant gas, and the vertical axis indicates the elapsed time (h) from when the introduction of the reactant gas into the reactor 40 is started until the first catalyst 41 is activated. From the results shown by the line segment L11, it was found that within the range of the H₂/N₂ ratio in the reactant gas from 0.5 to 3.0, a smaller H₂/N₂ ratio can shorten the elapsed time from when the introduction of the reactant gas into the reactor 40 is started until the first catalyst 41 is activated.

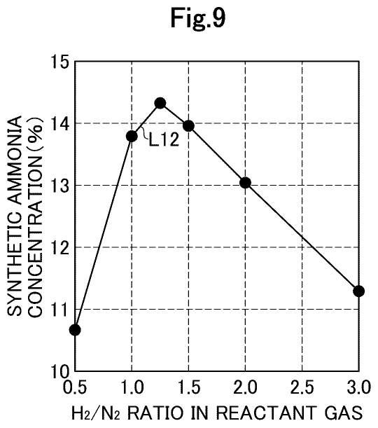

FIG. 9 shows a line segment L12 which represents correspondence relationship between each reactant gas with a different H₂/N₂ ratio introduced into the reactor 40 and the synthetic ammonia concentration at the reaction stabilization time. In FIG. 9, the horizontal axis indicates the H₂/N₂ ratio in the reactant gas, and the vertical axis indicates the synthetic ammonia concentration (%) in the post-reaction gas discharged from the reactor 40 at the reaction stabilization time. From the results shown by the line segment L12, it was found that when the H₂/N₂ ratio in the reactant gas was 1.25, the synthesized ammonia concentration at the reaction stabilization time was maximized. The line segment L12 shows that, for the reactant gases with the H₂/N₂ ratio lower than 1.25, a lower H₂/N₂ ratio results in a lower synthetic ammonia concentration at the reaction stabilization time. This is inferred from the fact that the lower the H₂/N₂ ratio in the reactant gas, the more likely it is that the ammonia equilibrium concentration is reached at the reaction stabilization time, and that, as shown in the line segment L10 in FIG. 7, for the reactant gases with the H₂/N₂ ratio lower than 1.5, a lower H₂/N₂ ratio results in a lower temperature of the first catalyst 41 at the reaction stabilization time.

From the measurement results shown in each of FIGS. 4 to 9 described above, in the ammonia synthesis system 1 under conditions where a gauge pressure is 8 MPaG and temperatures of the reactant gas passing through the upstream heater 45 and the downstream heater 46 are 350° C. and 400° C., respectively, it was found that it is appropriate to set the H₂/N₂ ratio in the reactant gas introduced into the reactor 40 during the pre-activation operation to 0.5, and to set the H₂/N₂ ratio in the reactant gas introduced into the reactor 40 during the post-activation operation to 1.25. Therefore, in the ammonia synthesis system 1, the controller 50 controls the H₂/N₂ ratio during the pre-activation operation to be 0.5, and controls the H₂/N₂ ratio during the post-activation operation to be 1.25. That is, the controller 50 controls the H₂/N₂ ratio during the pre-activation operation to be smaller than the H₂/N₂ ratio during the post-activation operation.

In addition to controlling the H₂/N₂ ratio in the reactant gas introduced into the reactor 40, the controller 50 also controls the flow rate of the reactant gas introduced into the reactor 40. The controller 50 controls the flow rate of the reactant gas introduced into the reactor 40 by adjusting the hydrogen and nitrogen amounts supplied to the first mixer 10 in a similar manner to controlling the H₂/N₂ ratio. In the present embodiment, the controller 50 controls the flow rate of the reactant gas during the pre-activation operation to be smaller than the flow rate during the post-activation operation. Such control allows the reactant gas heated by the ammonia synthesis reaction, to be retained in the reactor 40 for a longer period of time during the pre-activation operation.

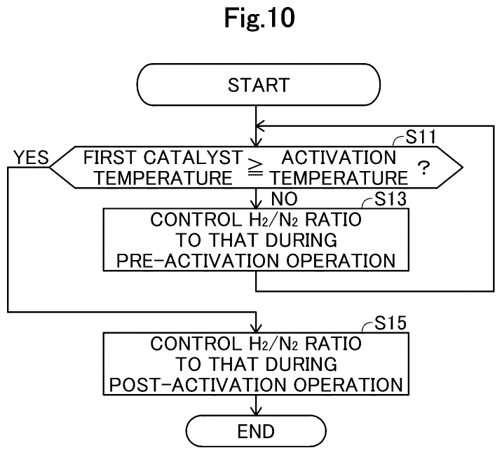

FIG. 10 is a flowchart illustrating an example of a procedure for a control process of the H₂/N₂ ratio. The control process of the H₂/N₂ ratio is performed periodically while the ammonia synthesis system 1 is in operation. When the control process of the H₂/N₂ ratio is started, the controller 50 first determines whether the temperature of the first catalyst 41 is equal to or higher than the activation temperature (step S11). The temperature of the first catalyst 41 may be acquired by a temperature sensor that directly detects the temperature of the first catalyst 41, or may be calculated using a value acquired by a temperature sensor that detects the temperature of the reactant gas flowing near the first catalyst 41 (on at least one of the upstream and downstream sides of the first catalyst 41). The activation temperature associated with activation of the first catalyst 41 is set in advance.

If the temperature of the first catalyst 41 is lower than the activation temperature (step S11: NO), the controller 50 controls the H₂/N₂ ratio in the reactant gas introduced into the reactor 40 to be the H₂/N₂ ratio preset as the H₂/N₂ ratio during the pre-activation operation (step S13). Thereafter, the controller 50 performs the process of step S11 again. On the other hand, if the temperature of the first catalyst 41 is equal to or higher than the activation temperature (step S11: YES), the controller 50 controls the H₂/N₂ ratio in the reactant gas introduced into the reactor 40 to be the H₂/N₂ ratio preset as the H₂/N₂ ratio during the post-activation operation (step S15). After performing the process of step S15, the controller 50 ends the control process of the H₂/N₂ ratio. In both steps S13 and S15, the controller 50 adjusts the hydrogen and nitrogen amounts supplied to the first mixer 10 to control the H₂/N₂ ratio.

As described above, according to the ammonia synthesis system 1 of the first embodiment, the H₂/N₂ ratio in the reactant gas introduced before the activation of the first catalyst 41 and the H₂/N₂ ratio in the reactant gas introduced after the activation of the first catalyst 41 can be controlled to be different values. Therefore, the H₂/N₂ ratio in the reactant gas introduced into the first catalyst 41 can be adjusted to an appropriate value for each of the pre-activation duration and the post-activation duration.

Therefore, ammonia can be synthesized more efficiently than in a case where the same H₂/N₂ ratio in the reactant gas introduced into the first catalyst 41 is used for both of the pre-activation duration and the post-activation duration.

Moreover, in the ammonia synthesis system 1 of the first embodiment, the H₂/N₂ ratio during the pre-activation operation is controlled to be smaller than the H₂/N₂ ratio during the post-activation operation. Therefore, in the case where the ammonia synthesis system 1 includes the first catalyst 41 in which the H₂/N₂ ratio appropriate for ammonia synthesis before catalyst activation is smaller than the H₂/N₂ ratio appropriate for ammonia synthesis after catalyst activation, a reactant gas with an appropriate H₂/N₂ ratio can be introduced into the first catalyst 41 for each of the pre-activation duration and the post-activation duration, and thus efficient ammonia synthesis can be achieved. Specifically, introducing a reactant gas with an appropriate H₂/N₂ ratio into the first catalyst 41 during the pre-activation operation makes it possible to activate the first catalyst 41 at a low temperature (see FIG. 7), and shorten the time required for the first catalyst 41 to be activated (see FIG. 8), thereby reducing the time required for activation and the energy input for activation.

In addition, in the ammonia synthesis system 1 of the first embodiment, the flow rate of the reactant gas introduced into the reactor 40 during the pre-activation operation is controlled to be smaller than the flow rate of the reactant gas introduced into the reactor 40 during the post-activation operation. Therefore, the reactant gas that is heated by the ammonia synthesis reaction after the introduction into the reactor 40 can be retained in the reactor 40 for a longer period of time. As a result, the contact time between the heated reactant gas and the first catalyst 41 (and the second catalyst 42) can be extended, and the temperature rise of the first catalyst 41 (and the second catalyst 42) can be promoted.

### Example 2

An ammonia synthesis system of a second embodiment is the same as the ammonia synthesis system 1 of the first embodiment, except that the H₂/N₂ ratio in the reactant gas introduced into the reactor 40 is varied during the pre-activation operation, as compared with the ammonia synthesis system 1 of the first embodiment.

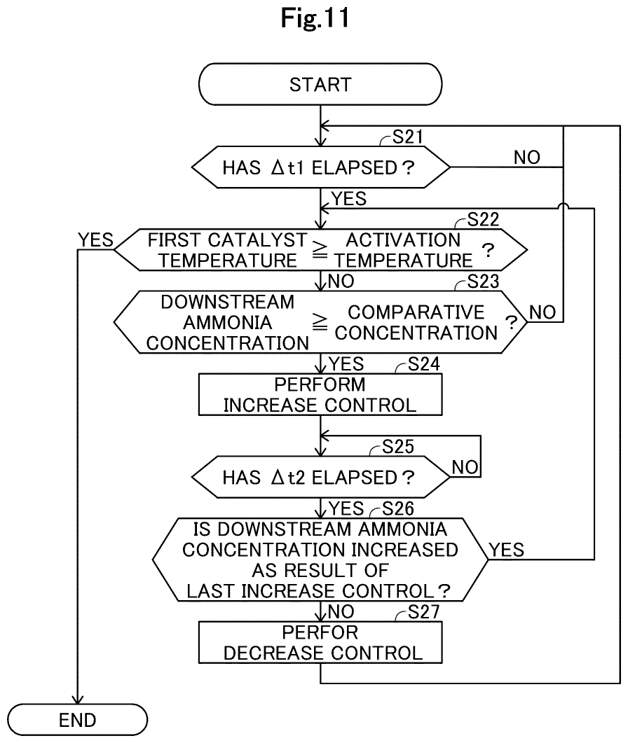

FIG. 11 is a flowchart illustrating an example of a procedure for a varying process of the H₂/N₂ ratio. The varying process of the H₂/N₂ ratio is performed periodically during the pre-activation operation. In the present embodiment, during the pre-activation operation, the H₂/N₂ ratio is initially controlled to be 0.5, and the H₂/N₂ ratio is varied by an increase control (described later) and a decrease control (described later) performed during the varying process of the H₂/N₂ ratio.

When the varying process of the H₂/N₂ ratio is started, the controller 50 first determines whether a set time delta t1 has elapsed since the start of the varying process of the H₂/N₂ ratio (step S21). If the set time delta t1 has not elapsed (step S21: NO), the controller 50 repeats step S21 until the set time delta t1 elapses.

When the set time delta t1 has elapsed (step S21: YES), the controller 50 determines whether the temperature of the first catalyst 41 is equal to or higher than the activation temperature (step S22). If the temperature of the first catalyst 41 is lower than the activation temperature (step S22: NO), the controller 50 determines whether a downstream ammonia concentration detected downstream of the first catalyst 41 is higher than a comparative concentration (step S23). The downstream ammonia concentration is detected by a gas sensor (not illustrated) provided in the reactor 40 between the first catalyst 41 and the second catalyst 42. The comparative concentration here refers to a concentration obtained by multiplying a predetermined ratio Z by an ammonia concentration in an equilibrium state calculated from the temperature of the first catalyst 41 (corresponding to the above-mentioned ammonia equilibrium concentration). The temperature of the first catalyst 41 used in calculating the comparative concentration is the temperature of the first catalyst 41 at approximately the same time as the detection of the downstream ammonia concentration to be compared. If it is difficult to acquire the temperature of the first catalyst 41 at approximately the same time, it is preferable to use the temperature of the first catalyst 41 at a time as close as possible to the time when the downstream ammonia concentration to be compared is detected. The ammonia concentration in the equilibrium state is acquired using a map in which the temperature of the first catalyst 41 is associated with the ammonia concentration in the equilibrium state at that temperature. The predetermined ratio Z is set to an arbitrary value in the range from 0.5 to 1, both inclusive, and in the present embodiment, is fixed to 0.8. That is, in the present embodiment, in step S23, the controller 50 determines whether the downstream ammonia concentration is higher than the comparative concentration obtained by multiplying the ammonia equilibrium concentration (the ammonia concentration in the reactor 40 in an equilibrium state under temperature conditions in the reactor 40 at approximately the same time as the detection of the downstream ammonia concentration) by 0.8. The predetermined ratio Z may be varied appropriately depending on the temperature of the first catalyst 41 and the H₂/N₂ ratio in the reactant gas. If the downstream ammonia concentration is not higher than the comparative concentration (step S23: NO), the controller 50 performs the process of step S21 again and determines whether the set time delta t1 has elapsed since the end of the process of step S23 (step S21).

On the other hand, if the downstream ammonia concentration is higher than the comparative concentration (step S23: YES), the controller 50 performs the increase control to increase the H₂/N₂ ratio in the reactant gas introduced into the reactor 40 (step S24). In the varying process of the H₂/N₂ ratio illustrated in FIG. 11, if the increase control is executed for the first time, the controller 50 updates the H₂/N₂ ratio to a value (0.5+delta X) obtained by adding delta X to the initial H₂/N₂ ratio for the pre-activation operation (0.5), and adjusts the hydrogen and nitrogen amounts supplied to the first mixer 10 such that the reactant gas has the updated H₂/N₂ ratio. Delta X is set to any value within a range from 0.01 to 0.1, both inclusive.

After performing the increase control (step S24), the controller 50 determines whether a set time delta t2 has elapsed (step S25). If the set time delta t2 has not elapsed (step S25: NO), the controller 50 repeats step S25 until the set time delta t2 has elapsed. The length of the set time delta t2 and the length of the set time delta t1 in step S21 may be the same or different.

When the set time delta t2 has elapsed (step S25: YES), the controller 50 determines whether the downstream ammonia concentration after the set time delta t2 has elapsed from increasing the H₂/N₂ ratio is higher than the downstream ammonia concentration that triggered the last increase control (step S26). Here, the downstream ammonia concentration that triggered the last increase control refers to the downstream ammonia concentration when the downstream ammonia concentration last became higher than the comparative concentration (step S23: YES). In other words, the downstream ammonia concentration that triggered the last increase control is the downstream ammonia concentration when the downstream ammonia concentration became equal to or greater than the comparative concentration in a state in which the reactant gas having the H₂/N₂ ratio before the last increase control was introduced into the reactor 40. Specifically, for example, when the increase control has been performed only once, the downstream ammonia concentration that triggered the last increase control refers to the downstream ammonia concentration when the downstream ammonia concentration became equal to or higher than the comparative concentration in a state where a reactant gas with an initial H₂/N₂ ratio (0.5 in the present embodiment) before the first increase control was introduced into the reactor 40, and when the increase control has been performed N times (Nis an integer of 2 or more), the downstream ammonia concentration that triggered the last increase control refers to the downstream ammonia concentration when the downstream ammonia concentration became equal to or higher than the comparative concentration in a state where a reactant gas with an H₂/N₂ ratio after the (N−1)th increase control was introduced into the reactor 40. That is, in step S26, the controller 50 determines whether the downstream ammonia concentration has increased as a result of the last increase control.

If the downstream ammonia concentration after the set time delta t2 has elapsed since the H₂/N₂ ratio was increased is higher than the downstream ammonia concentration that triggered the last increase control (step S26: YES), the controller 50 performs the process of step S22 again. Then, if the temperature of the first catalyst 41 is lower than the activation temperature (step S22; NO) and the downstream ammonia concentration is higher than the comparative concentration (step S23: YES), the controller 50 performs an additional increase control (step S24). That is, the controller 50 performs the additional increase control each time the downstream ammonia concentration after the set time delta t2 has elapsed since the H₂/N₂ ratio was increased is higher than the downstream ammonia concentration that triggered the last increase control (step S26: YES) and is higher than the comparative concentration (step S23: YES). In this increase control, the H₂/N₂ ratio is also updated to a value obtained by adding delta X to the current H₂/N₂ ratio.

On the other hand, if the downstream ammonia concentration after the set time delta t2 has elapsed since the H₂/N₂ ratio was increased is lower than the downstream ammonia concentration that triggered the last increase control (step S26: NO), the controller 50 performs the decrease control to restore the H₂/N₂ ratio to the H₂/N₂ ratio before the last increase control (step S27). In the decrease control, the controller 50 updates the H₂/N₂ ratio to a value obtained by subtracting delta X from the current H₂/N₂ ratio (current H₂/N₂ ratio-delta X), and adjusts the hydrogen and nitrogen amounts supplied to the first mixer 10 to obtain a reactant gas with the updated H₂/N₂ ratio. Specifically, for example, if the increase control has been performed only once, the H₂/N₂ ratio is restored to the initial H₂/N₂ ratio before the first increase control (0.5 in the present embodiment), and if the increase control has been performed N times (N is an integer of 2 or more), the H₂/N₂ ratio is restored to the H₂/N₂ ratio when the (N−1)th increase control was performed. After performing the decrease control (step S27), the controller 50 performs the process of step S21 again, and determines whether the set time delta t1 has elapsed since the end of the process of step S27 (step S21).

As described above, the controller 50 performs the processes of each of steps S21 to S27 described above. Then, when the temperature of the first catalyst 41 becomes equal to or higher than the activation temperature (step S22), the controller 50 ends the varying process of the H₂/N₂ ratio. That is, the operating state of the ammonia synthesis system of the second embodiment transitions from the pre-activation operation to the post-activation operation. Thus, the controller 50 adjusts the hydrogen and nitrogen amounts supplied to the first mixer 10 to achieve the H₂/N₂ ratio during the post-activation operation (1.25 as in the first embodiment).

As described above, according to the ammonia synthesis system of the second embodiment, during the pre-activation operation, each time the downstream ammonia concentration after the set time delta t2 has elapsed since the H₂/N₂ ratio was increased becomes higher than the downstream ammonia concentration that triggered the last increase control and becomes higher than the comparative concentration, additional increase control is performed, and thus the H₂/N₂ ratio in the reactant gas during the pre-activation operation can be increased stepwise to approach an optimum value. Therefore, ammonia can be synthesized more efficiently during the pre-activation operation. On the other hand, during the pre-activation operation, if the downstream ammonia concentration after the set time delta t2 has elapsed since the H₂/N₂ ratio was increased is lower than the downstream ammonia concentration that triggered the last increase control, then the decrease control is performed, and thus it is possible to prevent the H₂/N₂ ratio in the reactant gas during the pre-activation operation from continuing to increase beyond the optimal value.

### Example 3

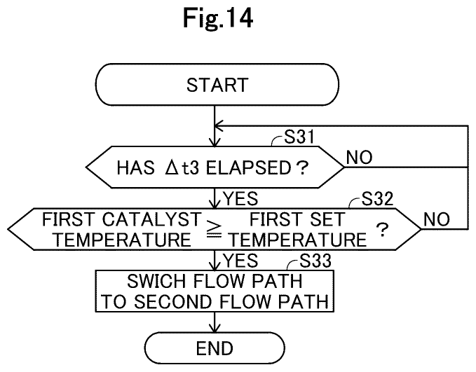

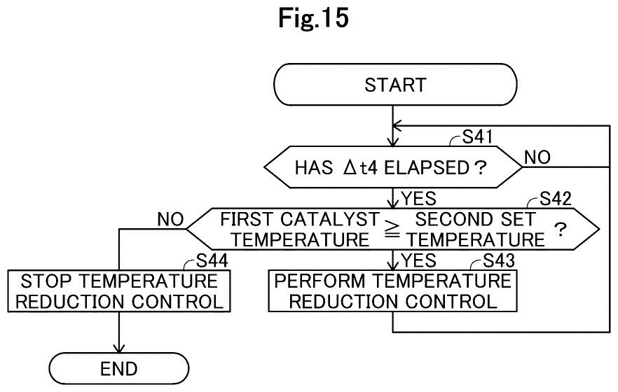

An ammonia synthesis system la of a third embodiment is generally the same as the ammonia synthesis system 1 of the first embodiment. The main difference from the ammonia synthesis system 1 of the first embodiment is that, the ammonia synthesis system la includes a flow path switching portion 91 and a flow path switching portion 92, and performs a flow path switching process described with reference to FIG. 14 and a temperature adjustment process described with reference to FIG. 15.

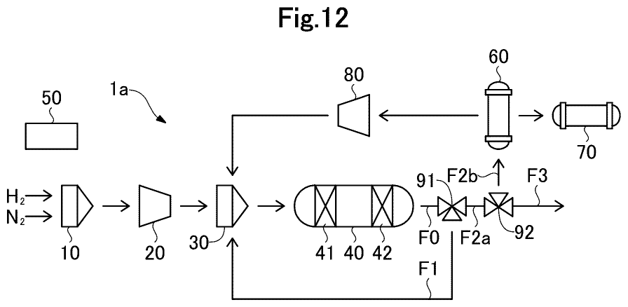

FIG. 12 is an explanatory diagram illustrating a configuration of the ammonia synthesis system 1a according to the third embodiment. The flow path switching portion 91 is a three-way valve connected to the reactor 40 via a flow path F0. The flow path switching portion 91 switches a flow path through which the post-reaction gas flows between a flow path F1 connecting the flow path switching portion 91 and the second mixer 30, and a flow path F2a connecting the flow path switching portion 91 and the flow path switching portion 92. The flow path switching portion 92 is a three-way valve connected to the flow path switching portion 91 via the flow path F2a. The flow path switching portion 92 switches the flow path through which the post-reaction gas flows between a flow path F2b connecting the flow path switching portion 92 and the gas-liquid separator 60 and a flow path F3 for discharging the post-reaction gas to the outside of the ammonia synthesis system 1a.

For example, when the flow path through which the post-reaction gas flows is switched to the flow path F1, the post-reaction gas is circulated to the upstream side of the reactor 40 (the second mixer 30 in the present embodiment) without passing through the gas-liquid separator 60 corresponding to a cooler that cools the post-reaction gas. On the other hand, when the flow path through which the post-reaction gas flows is switched to the flow path F2a and the flow path F2b, the post-reaction gas is fed to the gas-liquid separator 60 which is the cooler. That is, the flow path switching portion 91 and the flow path switching portion 92 can switch the flow path through which the post-reaction gas flows between a first flow path (the flow path F1 in the present embodiment) for circulating the post-reaction gas to the upstream side of the reactor 40 without passing through the cooler (the gas-liquid separator 60 in the present embodiment), and a second flow path (the flow path F2a and the flow path F2b in the present embodiment) for feeding the post-reaction gas to the cooler.

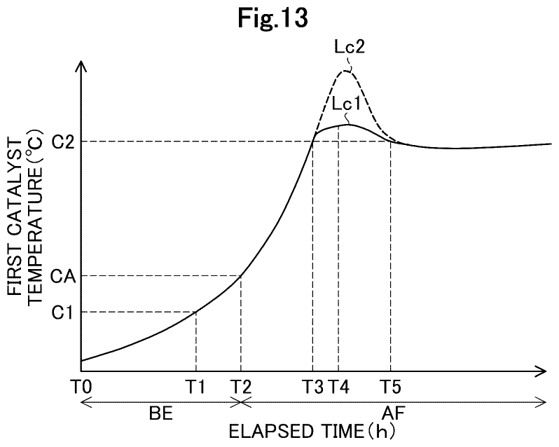

FIG. 13 is an explanatory diagram showing an example of transition of temperature change of the first catalyst 41 from when introduction of the reactant gas into the reactor 40 is started. In FIG. 13, the horizontal axis indicates the elapsed time (h), and the vertical axis indicates the temperature (° C.) of the first catalyst 41. The period from a timing TO to a timing T2 corresponds to a pre-activation operation BE. That is, after the pre-activation operation BE is started at the timing T0, the temperature of the first catalyst 41 reaches an activation temperature CA at the timing T2. On the other hand, the period after the timing T2 corresponds to a post-activation operation AF. A solid line segment Lc1 and a dashed line segment Lc2 that branch off from each other after a timing T3 during the post-activation operation AF will be described in detail later.

In FIG. 13, a first set temperature C1 is a temperature that is set within a temperature range lower than the activation temperature CA. The first set temperature C1 is set by taking into consideration the H₂/N₂ ratio in the reactant gas introduced into the reactor 40 and the reaction efficiency of the ammonia synthesis reaction depending on the temperature of the first catalyst 41, and is set, for example, within a range having a lower limit that is 100° C. lower than the activation temperature CA. During the pre-activation operation BE, when the temperature of the first catalyst 41 is lower than the first set temperature C1, the controller 50 controls the flow path switching portion 91 to switch the flow path through which the post-reaction gas flows to the first flow path (the flow path F1 in the present embodiment). On the other hand, during the pre-activation operation BE, when the temperature of the first catalyst 41 is higher than or equal to the first set temperature C1, the controller 50 controls the flow path switching portions 91, 92 to switch the flow path through which the post-reaction flows to the second flow path (the flow path F2a and the flow path F2b in the present embodiment). The flow path switching process for switching the flow path in this manner is performed during the pre-activation operation BE. In FIG. 13, during the pre-activation operation BE, the post-reaction gas flows through the first flow path for a period of time from the timing TO to a timing T1, and the post-reaction gas flows through the second flow path for a period of time from the timing T1 to the timing T2.

The post-reaction gas is at a relatively high temperature because the reactant gas that is heated in the upstream heater 45 and the downstream heater 46 and then introduced into the reactor 40, is further subjected to the exothermic ammonia synthesis reaction before being discharged from the reactor 40. Thus, in the ammonia synthesis system la of the third embodiment, while the temperature of the first catalyst 41 is lower than the first set temperature C1, the post-reaction gas flows through the first flow path and circulates again to the upstream side of the reactor 40 without being cooled by the gas-liquid separator 60, which is the cooler, and the thermal energy of the post-reaction gas is reused for heating the first catalyst 41 and the second catalyst 42. In addition, since a relatively large amount of unreacted hydrogen and unreacted nitrogen remains in the post-reaction gas while the temperature of the first catalyst 41 is lower than the first set temperature C1, the amount of reactant gas newly introduced into the reactor 40 can be reduced depending on the amount of circulated post-reaction gas. For example, when the flow path switching portion 91 can adjust the flow rate of the post-reaction gas flowing through the flow path F1, the amount of reactant gas newly introduced into the reactor 40 may be decreased with increase of the flow rate of the post-reaction gas flowing through the flow path F1. Furthermore, when the flow path switching portion 91 cannot adjust the flow rate of the post-reaction gas flowing through the flow path F1 and the flow rate of the post-reaction gas flowing through the flow path F1 is approximately constant, the amount of reactant gas newly introduced into the reactor 40 when the post-reaction gas flows through the flow path F1 may be decreased compared to when no post-reaction gas flows through the flow path F1.

In addition to performing the flow path switching process during the pre-activation operation BE, the controller 50 performs the temperature adjustment process for adjusting the temperature of the first catalyst 41 during the post-activation operation AF. In FIG. 13, the solid line segment Lcl represents a temperature change of the first catalyst 41 when the temperature adjustment process according to the present embodiment is performed. The dashed line segment Lc2 represents, as a comparative example, the temperature change of the first catalyst 41 when the temperature adjustment process is not performed. Note that a part of the dashed line segment Lc2 that joins with the solid line segment Lcl after a timing T5 overlaps with the solid line segment Lc1.

In FIG. 13, a second set temperature C2 is a temperature that is set within a temperature range higher than the activation temperature CA. The second set temperature C2 is set by taking into consideration the H₂/N₂ ratio in the reactant gas introduced into the reactor 40, transition of the temperature rise in the first catalyst 41 after activation, a temperature associated with beginning of degradation of the first catalyst 41, and the like. During the post-activation operation AF, when the temperature of the first catalyst 41 is higher than the second set temperature C2, the controller 50 performs temperature reduction control to reduce the temperature of the first catalyst 41. The controller 50 reduces the H₂/N₂ ratio in the reactant gas introduced into the reactor 40 as the temperature reduction control. For example, in the case where the H₂/N₂ ratio in the reactant gas during the post-activation operation is controlled to be 1.25, as in the first and second embodiments, the controller 50 controls the H₂/N₂ ratio in the reactant gas to be less than 1.25. When the H₂/N₂ ratio in the reactant gas is decreased, the amounts of hydrogen and nitrogen used in the ammonia synthesis reaction decrease, and the amount of heat generated by the synthesis reaction decreases. As a result, the temperature of the first catalyst 41 can be lowered. In this manner, the temperature adjustment process for adjusting the temperature of the first catalyst 41 is performed during the post-activation operation AF. In FIG. 13, as a result of performing, during the post-activation operation AF, the temperature reduction control triggered by the temperature of the first catalyst 41 becoming higher than the second set temperature C2 at the timing T3, a sudden temperature rise of the first catalyst 41 on the solid line segment Lc1 is suppressed compared to the dashed line segment Lc2. Thereafter, at the timing T5, the temperature of the first catalyst 41 becomes equal to or lower than the second set temperature C2, which triggers stop of the temperature reduction control. Note that, even after the timing T5, as long as the post-activation operation AF continues, when the temperature of the first catalyst 41 becomes higher than the second set temperature C2 again, the temperature reduction control is performed again. Note that, in FIG. 13, a timing T4 corresponds to the reaction stabilization time in the temperature change of the first catalyst 41 represented by the solid line segment Lc1.

When the catalyst is activated, the temperature of the catalyst rises rapidly. Such rapid increase may cause the catalyst temperature to remain high and thus cause thermal degradation of the catalyst. As described above, in the ammonia synthesis system la of the third embodiment, the temperature reduction control is performed when the temperature of the first catalyst 41 is higher than the second set temperature C2, thereby reducing the risk of thermal degradation of the first catalyst 41.

FIG. 14 is a flowchart illustrating an example of a procedure for the flow path switching process. The flow path switching process is performed when the pre-activation operation is started. It is assumed that, at the time when the flow path switching process is started, the flow path through which the post-reaction gas flows is set to the first flow path.

When the flow path switching process is started, the controller 50 first determines whether a set time delta t3 has elapsed from the start of the flow path switching process (step S31). If the set time delta t3 has not elapsed (step S31: NO), the controller 50 repeats step S31 until the set time delta t3 elapses.

On the other hand, if the set time delta t3 has elapsed (step S31: YES), the controller 50 determines whether the temperature of the first catalyst 41 is equal to or higher than the first set temperature C1 (step S32). If the temperature of the first catalyst 41 is lower than the first set temperature C1 (step S32: NO), the controller 50 again performs the processing of step S31 and determines whether the set time delta t3 has elapsed from completion of the processing of step S32 (step S31). At this time, the flow path through which the post-reaction gas flows is still set to the first flow path.

On the other hand, if the temperature of the first catalyst 41 is equal to or higher than the first set temperature C1 (step S32: YES), the controller 50 controls the flow path switching portions 91, 92 to switch the flow path through which the post-reaction gas flows, to the second flow path (step S33). Thereafter, the controller 50 ends the flow path switching process.

FIG. 15 is a flowchart illustrating an example of a procedure for the temperature adjustment process. The temperature adjustment process is repeatedly performed during the post-activation operation. When the temperature adjustment process is started, the controller 50 first determines whether a set time delta t4 has elapsed from the start of the temperature adjustment process (step S41). If the set time delta t4 has not elapsed (step S41: NO), the controller 50 repeats step S41 until the set time delta t4 elapses.

On the other hand, if the set time delta t4 has elapsed (step S41: YES), the controller 50 determines whether the temperature of the first catalyst 41 is higher than the second set temperature C2 (step S42). If the temperature of the first catalyst 41 is higher than the second set temperature C2 (step S42: YES), the controller 50 performs the temperature reduction control to reduce the temperature of the first catalyst 41 (step S43). Thereafter, the controller 50 performs the process of step S41 again, and determines whether the set time delta t4 has elapsed from the completion of the process of step S43 (step S41). In the present embodiment, if YES is determined again in step S42 (step S42: YES) after the temperature reduction control and before processing of step S44 described below, the controller 50 performs additional temperature reduction control. In the additional temperature reduction control, the H₂/N₂ ratio in the reactant gas, which has been decreased by the last performed temperature reduction control, is further decreased by the additional temperature reduction control. In this manner, in the temperature adjustment process, the temperature reduction control is repeated until the temperature of the first catalyst 41 becomes equal to or lower than the second set temperature C2, thereby stepwise decreasing the H₂/N₂ ratio in the reactant gas.

On the other hand, if the temperature of the first catalyst 41 is equal to or lower than the second set temperature C2 (step S42: NO), the controller 50 stops the temperature reduction control (step S44). At this time, the H₂/N₂ ratio in the reactant gas is controlled to be the value before the temperature reduction control is performed (at the start of the post-activation operation). If the temperature reduction control is not being performed at the time when the process of step S44 is performed, the H₂/N₂ ratio in the reactant gas is maintained at the value at the start of the post-activation operation. After the process of step S44, the controller 50 ends the temperature adjustment process. Even after the end of the temperature adjustment process, the temperature adjustment process is repeatedly performed as long as the post-activation operation continues, as described above.

As described above, according to the ammonia synthesis system la of the third embodiment, while the temperature of the first catalyst 41 is lower than the first set temperature C1, the post-reaction gas is circulated again to the upstream side of the reactor 40 without being cooled in the gas-liquid separator 60, and therefore the thermal energy of the post-reaction gas can be reused for heating the first catalyst 41 and the second catalyst 42. In addition, since a relatively large amount of unreacted hydrogen and unreacted nitrogen remains in the post-reaction gas while the temperature of the first catalyst 41 is lower than the first set temperature C1, the amount of reactant gas newly introduced into the reactor 40 can be reduced depending on the amount of circulated post-reaction gas. That is, according to the ammonia synthesis system la of the third embodiment, by circulating the post-reaction gas, it is possible to reduce the energy required to generate the reactant gas (particularly the energy required to generate hydrogen) and the thermal energy required to heat the reactant gas.

As a comparative example, if the post-reaction gas is not circulated to the upstream side of the reactor 40 even while the temperature of the first catalyst 41 is lower than the first set temperature C1, the post-reaction gas is fed to the gas-liquid separator 60 via the flow path F2b, or is discharged to the outside of the ammonia synthesis system la via the flow path F3. In the former case, the thermal energy contained in the post-reaction gas is lost by cooling in the gas-liquid separator 60. In the latter case, the thermal energy of the post-reaction gas and the unreacted hydrogen and nitrogen that are relatively abundant in the post-reaction gas are wasted. In this regard, according to the ammonia synthesis system la of the third embodiment, by circulating the post-reaction gas to the upstream side of the reactor 40 via the first flow path, it is possible to reuse the thermal energy of the post-reaction gas and the unreacted hydrogen and unreacted nitrogen that are relatively abundant in the post-reaction gas, and therefore it is possible to save energy consumed during the operation of the ammonia synthesis system 1 during the pre-activation operation.

Furthermore, in the ammonia synthesis system 1a of the third embodiment, the temperature reduction control is performed when the temperature of the first catalyst 41 is higher than the second set temperature C2, and thus the risk of thermal degradation of the first catalyst 41 can be reduced.

### Variations of Present Examples

The present invention is not limited to the above-described embodiment, and can be embodied in various forms without departing from the spirit and scope of the invention. For example, the following variations are possible.

### Variation 1

The above embodiments are merely examples, and various modifications can be made to the configuration, control, and the like of the ammonia synthesis system. For example, the ammonia synthesis system may not include the gas-liquid separator 60 and the tank 70, and another system connected to the ammonia synthesis system may include the gas-liquid separator 60 and the tank 70. The ammonia synthesis system may not include the first mixer 10 and the second mixer 30, and the gases may be mixed in a pipe connected to the reactor 40. In addition, in the above embodiment, the two catalysts (the first catalyst 41 and the second catalyst 42) are accommodated in the reactor 40, but the reactor 40 may accommodate only one catalyst.

### Variation 2

In the above embodiment, the controller 50 controls the H₂/N₂ ratio during the pre-activation operation to be smaller than the H₂/N₂ ratio during the post-activation operation, but the present disclosure is not limited thereto. The controller 50 may control the H₂/N₂ ratio during the pre-activation operation to be greater than the H₂/N₂ ratio during the post-activation operation. Such control makes it possible to efficiently synthesize ammonia in an ammonia synthesis system including a catalyst in which the H₂/N₂ ratio suitable for ammonia synthesis before catalyst activation is greater than the H₂/N₂ ratio suitable for ammonia synthesis after catalyst activation.

### Variation 3

In the above embodiment, the controller 50 controls the H₂/N₂ ratio in the reactant gas introduced into the reactor 40 and also controls the flow rate of the reactant gas introduced into the reactor 40, but the present disclosure is not limited thereto. For example, the controller 50 may control the H₂/N₂ ratio in the reactant gas introduced into the reactor 40, but may not control the flow rate of the reactant gas introduced into the reactor 40, and a controller separate from the controller 50 may control the flow rate of the reactant gas introduced into the reactor 40.

### Variation 4

In the above embodiment, if the temperature of the first catalyst 41 is equal to or higher than the activation temperature (step S11: YES), the controller 50 controls the H₂/N₂ ratio in the reactant gas introduced into the reactor 40 to be the H₂/N₂ ratio preset as the H₂/N₂ ratio during the post-activation operation (1.25 in the above embodiment) (step S15), but the present disclosure is not limited thereto. For example, after the temperature of the first catalyst 41 becomes equal to or higher than the activation temperature (step S11: YES), the controller 50 may perform control to gradually increase the H₂/N₂ ratio with subsequent temperature rise. In other words, instead of controlling the H₂/N₂ ratio to be the H₂/N₂ ratio preset as the H₂/N₂ ratio during the post-activation operation immediately after the temperature becomes equal to or higher than the activation temperature, the H₂/N₂ ratio may be increased with temperature rise after the temperature becomes equal to or higher than the activation temperature. In a case where a period from when the temperature of the first catalyst 41 becomes equal to or higher than the activation temperature until the reaction stabilization time has been confirmed in advance from experimental results, etc., the controller 50 may adjust the hydrogen and nitrogen amounts supplied to the first mixer 10 such that the H₂/N₂ ratio changes from the H₂/N₂ ratio during the pre-activation operation to the H₂/N₂ ratio during the post-activation operation after the start timing and before the end timing of that period.

In the above embodiment, the first flow path (the flow path F1) for circulating the post-reaction gas to the upstream side of the reactor 40 is connected to the second mixer 30, but the present disclosure is not limited thereto. The first flow path may be connected to any location on the upstream side of the reactor 40.

In the above embodiment, the temperature reduction control is performed only by reducing the H₂/N₂ ratio in the reactant gas introduced into the reactor 40, but the present disclosure is not limited thereto. For example, during temperature reduction control, in addition to reducing the H₂/N₂ ratio in the reactant gas, the amount of heat applied to the reactant gas by the upstream heater 45 and the downstream heater 46 (see FIG. 2) may be reduced, and/or the flow rate of the reactant gas introduced into the reactor 40 may be reduced. Also, for example, when the temperature reduction control is performed for the first time in the temperature adjustment process (FIG. 15), only reduction of the H₂/N₂ ratio in the reactant gas may be performed, and if YES is determined again in step S42, an additional temperature reduction control including reduction of the amount of heat applied to the reactant gas and/or reduction of the flow rate of the reactant gas, in addition to reduction of the H₂/N₂ ratio in the reactant gas, may be performed. In addition, each time the additional temperature reduction control is performed, in addition to stepwise decreasing the H₂/N₂ ratio in the reactant gas, the amount of heat applied to the reactant gas and/or the flow rate of the reactant gas may be stepwise decreased.

In the above embodiment, if YES is determined again in step S42 after the temperature reduction control, the additional temperature reduction control is performed, but the present disclosure is not limited thereto. If YES is determined again in step S42 after the temperature reduction control, an additional temperature reduction control may not be performed. In this case, the H₂/N₂ ratio in the reactant gas that has been reduced by the last temperature reduction control is maintained.

In the above embodiment, in the flow path switching process, switching the flow path through which the post-reaction gas flows from the first flow path to the second flow path is based on the comparison between the first catalyst 41 and the first set temperature C1, but the present disclosure is not limited thereto. For example, switching the flow path through which the post-reaction gas flows from the first flow path to the second flow path may be based on, in addition to the comparison between the first catalyst 41 and the first set temperature C1, comparison between the temperature of the second catalyst 42 and a set temperature set for the second catalyst 42. In this embodiment, when the temperature of the first catalyst 41 is equal to or higher than the first set temperature C1 and the temperature of the second catalyst 42 is equal to or higher than the set temperature set for the second catalyst 42, the flow path through which the post-reaction gas flows is switched from the first flow path to the second flow path. Similarly, in the temperature adjustment process, in addition to the comparison between the first catalyst 41 and the second set temperature C2, comparison between the temperature of the second catalyst 42 and a set temperature set for the second catalyst 42 may be used. In this embodiment, when the temperature of the first catalyst 41 is higher than the second set temperature C2 and the temperature of the second catalyst 42 is higher than or equal to the set temperature set for the second catalyst 42, the temperature reduction control is performed.

In the above embodiment, in the temperature adjustment process, the temperature reduction control is performed based on the comparison between the temperature of the first catalyst 41 and the second set temperature C2, but the present disclosure is not limited thereto. For example, the temperature reduction control is performed based on, in addition to the comparison between the temperature of the first catalyst 41 and the second set temperature C2, comparison between a temperature rise value of the first catalyst 41 per unit time (corresponding to the slope of the temperature change of the first catalyst 41 shown in FIG. 13) and a set temperature rise value. In this embodiment, the temperature reduction control is performed when the temperature of the first catalyst 41 is higher than the second set temperature C2 and the temperature rise value of the first catalyst 41 per unit time is greater than the set temperature rise value. The unit time here may be any length of time, but is preferably a unit time immediately preceding a point in time at which the comparison with the set temperature rise value is performed. The set temperature rise value is set by referring to an increase value per unit time of the temperature that rapidly rises after the first catalyst 41 is activated. In detail, the set temperature rise value is set such that when the temperature rise value of the first catalyst 41 per unit time is greater than the set temperature rise value, the first catalyst 41 can be regarded as being in a state in which the temperature is rising rapidly after activation.

The present aspect has been described above based on the embodiment and variations. However, the above-described embodiments of the aspect are intended to facilitate understanding of the present aspect and are not intended to limit the present aspect.

The present aspect may be modified or improved without departing from the spirit and scope of the claims, and includes equivalents thereof. Furthermore, a technical feature may be deleted as appropriate, unless the technical feature is not described in this specification as being essential.

The present invention can also be realized in the following forms.

### Application Example 1

An ammonia synthesis system for synthesizing ammonia, including:
a reactor accommodating a catalyst for promoting a synthesis reaction of ammonia from a reactant gas containing hydrogen and nitrogen; and
a controller that controls an H₂/N₂ ratio, the H₂/N₂ ratio being a ratio of hydrogen to nitrogen in the reactant gas introduced into the reactor, wherein
the controller controls the H₂/N₂ ratio during a pre-activation operation to be a value different from the H₂/N₂ ratio during a post-activation operation, the pre-activation operation being an operation for raising the temperature of the catalyst to an activation temperature associated with activation of the catalyst, the post-activation operation being an operation after the temperature of the catalyst reaches the activation temperature.

### Application Example 2

The ammonia synthesis system according to Application Example 1, wherein
the controller controls the H₂/N₂ ratio during the pre-activation operation to be smaller than the H₂/N₂ ratio during the post-activation operation.

### Application Example 3

The ammonia synthesis system according to Application Example 1 or Application Example 2, Wherein
during the pre-activation operation,
   when a downstream ammonia concentration detected downstream of the catalyst is higher than a comparative concentration obtained by multiplying a predetermined ratio by an ammonia concentration in an equilibrium state calculated from the temperature of the catalyst, the controller performs increase control to increase the H₂/N₂ ratio,
   each time the downstream ammonia concentration after a lapse of a set time from increasing the H₂/N₂ ratio becomes higher than the downstream ammonia concentration that triggered the last increase control and becomes higher than the comparative concentration, the controller additionally performs the increase control, and
   when the downstream ammonia concentration after a lapse of the set time from increasing the H₂/N₂ ratio is lower than the downstream ammonia concentration that triggered the last increase control, the controller performs decrease control to restore the H₂/N₂ ratio to the H₂/N₂ ratio before the last increase control.

### Application Example 4

The ammonia synthesis system according to any one of Application Example 1 to Application Example 3, wherein
the controller controls a flow rate of the reactant gas introduced into the reactor, and
the controller controls the flow rate of the reactant gas during the pre-activation operation to be smaller than the flow rate during the post-activation operation.

### Application Example 5

The ammonia synthesis system according to any one of Application Example 1 To Application Example 4, further including:
a cooler that cools a post-reaction gas discharged from the reactor; and
a flow path switching portion that switches a flow path of the post-reaction gas between a first flow path for circulating the post-reaction gas to an upstream side of the reactor without passing through the cooler and a second flow path for feeding the post-reaction gas to the cooler, wherein
during the pre-activation operation,
   when the temperature of the catalyst is lower than a first set temperature set within a temperature range lower than the activation temperature, the controller controls the flow path switching portion to switch the flow path to the first flow path, and
   when the temperature of the catalyst is equal to or higher than the first set temperature, the controller controls the flow path switching portion to switch the flow path to the second flow path.

### Application Example 6

The ammonia synthesis system according to any one of Application Example 1 to Application Example 5, wherein
during the post-activation operation, the controller performs temperature reduction control to reduce the temperature of the catalyst when the temperature of the catalyst is higher than a second set temperature set within a temperature range higher than the activation temperature.

### REFERENCE SIGNS LIST

1, 1a Ammonia synthesis system
10 First mixer
20 First compressor
30 Second mixer
40 Reactor
41 First catalyst
42 Second catalyst
43 Inner pipe
44 Outer pipe
45 Upstream heater
46 Downstream heater
50 Controller
60 Gas-liquid separator
70 Tank
80 Second compressor
91, 92 Flow path switching portion
F0, F1, F2a, F2b, F3 Flow path

1. An ammonia synthesis system for synthesizing ammonia, comprising:
a reactor accommodating a catalyst for promoting a synthesis reaction of ammonia from a reactant gas containing hydrogen and nitrogen; and
a controller configured to control an H₂/N₂ ratio, the H₂/N₂ ratio being a ratio of hydrogen to nitrogen in the reactant gas introduced into the reactor, wherein
the controller is configured to control the H₂/N₂ ratio during a pre-activation operation to be a value different from the H₂/N₂ ratio during a post-activation operation, the pre-activation operation being an operation for raising a temperature of the catalyst to an activation temperature associated with activation of the catalyst, the post-activation operation being an operation after the temperature of the catalyst reaches the activation temperature.

2. The ammonia synthesis system according to claim 1, wherein
the controller is configured to control the H₂/N₂ ratio during the pre-activation operation to be smaller than the H₂/N₂ ratio during the post-activation operation.

3. The ammonia synthesis system according to claim 1, wherein
during the pre-activation operation,
when a downstream ammonia concentration detected downstream of the catalyst is higher than a comparative concentration obtained by multiplying a predetermined ratio by an ammonia concentration in an equilibrium state calculated from the temperature of the catalyst, the controller is configured to perform increase control to increase the H₂/N₂ ratio,
each time the downstream ammonia concentration, after a lapse of a set time from increasing the H₂/N₂ ratio, becomes higher than the downstream ammonia concentration that triggered the last increase control and becomes higher than the comparative concentration, the controller is configured to additionally perform the increase control, and
when the downstream ammonia concentration, after a lapse of the set time from increasing the H₂/N₂ ratio, is lower than the downstream ammonia concentration that triggered the last increase control, the controller is configured to perform decrease control to restore the H₂/N₂ ratio to the H₂/N₂ ratio before the last increase control.

4. The ammonia synthesis system according to claim 1, wherein
the controller is configured to:
control a flow rate of the reactant gas introduced into the reactor, and
control the flow rate of the reactant gas during the pre-activation operation to be smaller than the flow rate during the post-activation operation.

5. The ammonia synthesis system according to claim 1, further comprising:
a cooler configured to cool a post-reaction gas discharged from the reactor; and
a flow path switching portion configured to switch a flow path of the post-reaction gas between a first flow path for circulating the post-reaction gas to an upstream side of the reactor without passing through the cooler and a second flow path for feeding the post-reaction gas to the cooler, wherein
during the pre-activation operation,
when the temperature of the catalyst is lower than a first set temperature set within a temperature range lower than the activation temperature, the controller is configured to control the flow path switching portion to switch the flow path to the first flow path, and
when the temperature of the catalyst is equal to or higher than the first set temperature, the controller is configured to control the flow path switching portion to switch the flow path to the second flow path.

6. The ammonia synthesis system according to claim 1, wherein
during the post-activation operation, the controller is configured to perform temperature reduction control to reduce the temperature of the catalyst when the temperature of the catalyst is higher than a second set temperature set within a temperature range higher than the activation temperature.

7. The ammonia synthesis system according to claim 2, wherein during the pre-activation operation,
when a downstream ammonia concentration detected downstream of the catalyst is higher than a comparative concentration obtained by multiplying a predetermined ratio by an ammonia concentration in an equilibrium state calculated from the temperature of the catalyst, the controller is configured to perform increase control to increase the H₂/N₂ ratio,
each time the downstream ammonia concentration, after a lapse of a set time from increasing the H₂/N₂ ratio, becomes higher than the downstream ammonia concentration that triggered the last increase control and becomes higher than the comparative concentration, the controller is configured to additionally perform the increase control, and
when the downstream ammonia concentration, after a lapse of the set time from increasing the H₂/N₂ ratio, is lower than the downstream ammonia concentration that triggered the last increase control, the controller is configured to perform decrease control to restore the H₂/N₂ ratio to the H₂/N₂ ratio before the last increase control.

8. The ammonia synthesis system according to claim 2, wherein
the controller is configured to:
control a flow rate of the reactant gas introduced into the reactor, and
control the flow rate of the reactant gas during the pre-activation operation to be smaller than the flow rate during the post-activation operation.

9. The ammonia synthesis system according to claim 2, further comprising:
a cooler configured to cool a post-reaction gas discharged from the reactor; and
a flow path switching portion configured to switch a flow path of the post-reaction gas between a first flow path for circulating the post-reaction gas to an upstream side of the reactor without passing through the cooler and a second flow path for feeding the post-reaction gas to the cooler, wherein
during the pre-activation operation,
when the temperature of the catalyst is lower than a first set temperature set within a temperature range lower than the activation temperature, the controller is configured to control the flow path switching portion to switch the flow path to the first flow path, and
when the temperature of the catalyst is equal to or higher than the first set temperature, the controller is configured to control the flow path switching portion to switch the flow path to the second flow path.

10. The ammonia synthesis system according to claim 2, wherein
during the post-activation operation, the controller is configured to perform temperature reduction control to reduce the temperature of the catalyst when the temperature of the catalyst is higher than a second set temperature set within a temperature range higher than the activation temperature.
